(19) United States
(12) Patent Application Publication
(10) Pub. No.: US 2021/0202151 A1
(43) Pub. Date: Jul. 1, 2021

(54) Reactor with High Common Mode Inductance

(71) Applicant: TDK Electronics AG, Munich (DE)

(72) Inventor: Tamas Horvath, Pecs (HU)

(21) Appl. No.: 17/045,311

(22) PCT Filed: May 17, 2019
(86) PCT No.: PCT/EP2019/062827

§ 371 Date: Oct. 5, 2020

(30) Foreign Application Priority Data
May 18, 2018 (DE) 102018112100.8

(51) Int. Cl. H01F 27/28; H01F 27/24

(52) U.S. Cl. CPC H01F 27/28; H01F 27/24

(57) ABSTRACT

In an embodiment, a reactor includes at least one winding and a magnetic core having at least a first leg and a second leg, and at least a first yoke and a second yoke, wherein the at least one winding is placed on at least one of the first leg and the second leg, and wherein at least one of the first and the second yoke has at least one airgap.

This patent application is a national phase filing under section 371 of PCT/EP2019/062827, filed May 17, 2019, which claims the priority of German patent application 102018112100.8, filed May 18, 2018, each of which is incorporated herein by reference in its entirety.

### TECHNICAL FIELD

The invention relates to a reactor having a high common mode inductance. The reactor can be used, for example, in a DC link of frequency converters, where the available space is seriously limited.

### BACKGROUND

The quality of the electric power is regulated by the relevant standard both from harmonic distortion and EMC compatibility point of view. Since frequency converters are non-linear loads, several measures are necessary to meet the standards and make those compatible to the electric main. The two key drive harmonic measurements are the Total Harmonic Content (THC) and the Partially Weighted Harmonic Content (PWHC).

To maintain those an inductive component must be used with the frequency converter. The inductive component can be either an external unit or integrated in the drive as well. Currently the most preferred solution is to install a choke in the DC link of the drive (called DC choke or DC reactor). Regarding the application of using a choke in a DC link of frequency converters, chokes were usually built from conventional “UI” or “EI” cores, where the chokes are intended to couple each branch-specific part.

### SUMMARY

Embodiments provide a reactor having a high common mode inductance and a small total volume by increased efficiency of cooling.

According to an embodiment of the reactor with high common mode inductance, the reactor comprises at least one winding and a magnetic core. The magnetic core has at least a first leg and a second leg, and at least a first yoke and a second yoke. The at least one winding is placed on at least one of the first leg and the second leg. At least one of the first and the second yoke has at least one airgap.

The reactor is a kind of filtering inductor, i.e., an inductor in which is a magnetic core, in which are the branch-specific pillars, around which are arranged the branch-specific windings. This solution has a special feature of which at least one airgap—depending on the application—are used in the yokes. The proposed solution allows to modify the coupling between each windings by using at least one airgap in the yokes and thus in the magnetic path between each windings so as increasing the magnetic resistance of it.

By using a gap in a yoke, it is possible to make the respective yoke, and thus the magnetic core, “opened”. The main advantage of the proposed design concept of the reactor is the increased effective cooling surface resulted by the “opening” of the yokes. The at least one airgap enables the air-flow through the windows so that cooling ability of the windings is much better than with the use of conventional design concepts, for example “UI”, “EI”, UU”, “EE”, of a magnetic core. The positive effect can be experienced most significantly, if forced air cooling is applied. However, in the case of natural convention, ensuring a path to the air through the yokes might have positive impact to.

Moreover, the magnetic characteristic such as the ratio of common-mode and differential mode inductance of the reactor/inductor will be more preferable for frequency converter applications. Thanks to the relatively high common mode inductance the EMC filtering of the frequency converter in which the reactor is used to fulfill the requirements of the relevant standards, for example IEC6100-3-12, will be easier. An additional advantage is the cost-efficiency due to less material content.

Additional features and advantages are set forth in the detailed description that follows and in part will be readily apparent to those skilled in the art from the description or recognized by practicing the embodiments as described in the written description and claims hereof, as well as the appended drawings. It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide further understanding, and are incorporated in and constitute a part of the specification. The drawings illustrate one or more embodiments, and together with the detailed description serve to explain principles and operation of the various embodiments. As such, the disclosure will become more fully understood from the following detailed description, taken in conjunction with the accompanying figures in which

FIG. 1 shows a first embodiment of a concept of a reactor with two branch-specific parts of a magnetic circuit;

FIG. 2 shows a second embodiment of a concept with two branch-specific parts of a magnetic circuit;

FIG. 3 shows a third embodiment of a concept with two branch-specific parts of a magnetic circuit;

FIG. 4 shows a first embodiment of a concept with three branch-specific parts of a magnetic circuit;

FIG. 5 shows a second embodiment of a concept with three branch-specific parts of a magnetic circuit;

FIG. 6 shows a third embodiment of a concept with three branch-specific parts of a magnetic circuit;

FIG. 7 shows a fourth embodiment of a concept with three branch-specific parts of a magnetic circuit;

FIG. 8 shows a fifth embodiment of a concept with three branch-specific parts of a magnetic circuit;

FIG. 9 shows a sixth embodiment of a concept with three branch-specific parts of a magnetic circuit; and

FIG. 10 shows a saturation curve of an embodiment of a reactor with high common mode inductance.

### DETAILED DESCRIPTION OF ILLUSTRATIVE EMBODIMENTS

An embodiment of a reactor/choke 1 with a high common mode inductance comprises at least one winding and a magnetic core 400. The magnetic core 400 has at least a first leg 10 and a second leg 20, as well as at least a first yoke 30 and a second yoke 40. The at least one winding is placed on at least one of the first leg 10 and the second leg 20. At least one of the first and the second yoke 30, 40 has at least one airgap 50.

When a current flow is generated in the at least one winding, a magnetic field is generated in the magnetic core 400 such that the magnetic field is guided within the magnetic core 400 from the first leg 10 via the first yoke 30 to the second leg 20 and from the second leg 20 via the second yoke 40 to the first leg 10. The first and the second leg 10, 20 are oriented vertically, and the first and the second yoke 30, 40 are positioned perpendicular, for example horizontally, to the first and second leg.

FIGS. 1 to 3 show various embodiments of the reactor 1, wherein there is at least one winding 100 and a second winding 200. The first winding 100 is placed on the first leg 10 and the second winding 200 is placed on the second leg 20. According to the embodiments of the reactor shown in FIGS. 1 to 3, the reactor comprises the two legs 10 and 20 without any additional leg/connection between these legs except of the yokes 30 and 40. The legs 10, 20 and the yokes 30, 40 have the same material.

According to the embodiment of the reactor shown in FIG. 1, the first leg 10 has an inner side face 11 facing to the inside of the magnetic core 400. The second leg 20 has an inner side face 21 facing to the inside of the magnetic core 400. The first yoke 30 has a front face 31 facing to the inner side face 21 of the second leg 20. The second yoke 40 has a front face 41 facing to the inner side face 11 of the first leg 10.

The magnetic core 400 comprises at least a first core part 410 and a second core part 420. The first core part 410 comprises the first leg 10 and the first yoke 30. The first leg 10 and the first yoke 30 are arranged so that the first core part 410 has a first L-shaped structure. The first L-shaped structure is made from one piece. The second core part 420 comprises the second leg 20 and the second yoke 40. The second leg 20 and the second yoke 40 are arranged so that the second core part 420 has a second L-shaped structure. The second L-shaped structure is made from one piece.

The at least one airgap 50 comprises a first airgap 51 and a second airgap 52. The first airgap 51 is arranged in the first yoke 30, and the second airgap 52 is arranged in the second yoke 40 so that the first and the second core part 410 and 420 are arranged spaced apart from each other.

In particular, the first core part 410 and the second core part 420 are arranged such that the first airgap 51 is arranged in the first yoke 30 so that the front face 31 of the first yoke 30 is arranged spaced apart from the second leg 20. As shown in FIG. 1, the first core part 410 and the second core part 420 are arranged such that the first airgap 51 is arranged in the first yoke 30 so that the front face 31 of the first yoke and the inner face 21 of the second leg 20 are arranged spaced apart from each other.

According to the embodiment of the reactor 1 shown in FIG. 1, the first core part 410 and the second core part 420 are arranged such that the second airgap 52 is arranged in the second yoke 40 so that the front face 41 of the second yoke 40 is arranged spaced apart from the first leg 10. In particular, the first core part 410 and the second core part 420 are arranged such that the second airgap 52 is arranged in the second yoke 40 so that the front face 41 of the second yoke 40 and the inner face 11 of the first leg 10 are arranged spaced apart from each other.

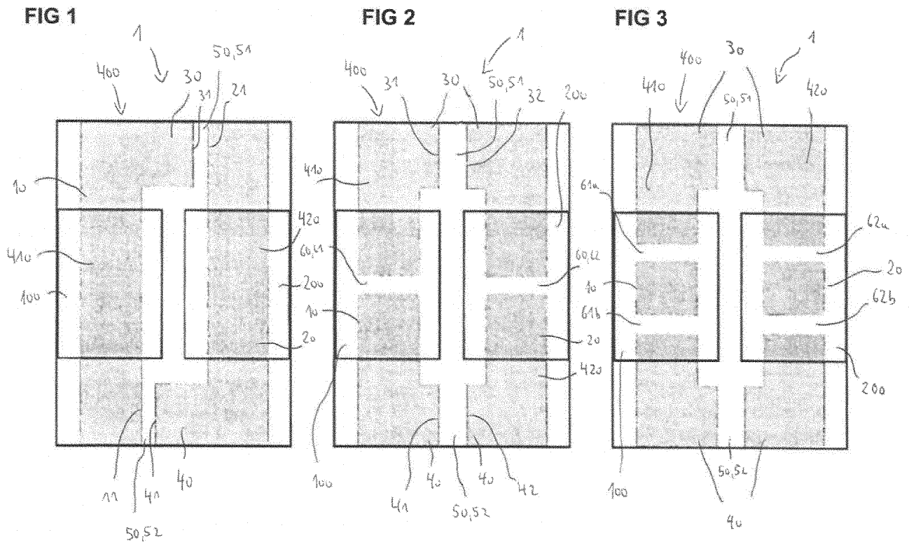

FIGS. 2 and 3 show other embodiments of the reactor 1, wherein in addition to the airgap 51 arranged in the first yoke 30 and the second airgap 52 arranged in the second yoke 40, at least one of the first and second leg 10, 20 has at least one other airgap 60. The first leg 10 may have at least a third airgap 61, and the second leg 20 may have at least a fourth airgap 62.

According to the embodiment of the reactor 1 shown in FIG. 2, an airgap 61 is arranged in the first leg 10, and a fourth airgap 62 is arranged in the second leg 20. According to the embodiment of the reactor 1 shown in FIG. 3, the first leg 10 has an airgap 62a and an additional airgap 62b. The second leg 20 has an airgap 62a and an additional airgap 62b.

According to the embodiments of a reactor/choke 1 shown in FIGS. 2 and 3, the first core part 410 and the second core part 420 are respectively configured as C-shaped parts. An airgap 51 is provided in the yoke 30, and another airgap 52 is provided in the yoke 40. The airgap 51 in the yoke 30 is arranged such that front faces 31, 32 of the yoke 30 and front faces 41, 42 of the yoke 40 are disposed a distance away from each other.

Regarding the embodiments of a reactor shown in FIGS. 1 to 3, the preferred shape of the magnetic core 400 is the L-shape as shown in FIG. 1. This shape allows for a bigger, more practical and useful size of the airgaps than the conventional designs with one or two gaps so that linearity of the inductance will be better under overload conditions. An additional advantage of the L-shaped structure of the first and second core part 410, 420 of the magnetic core 400 is that the self-inductance of each branch-specific part of the choke/reactor will be higher than it would be if an I-shaped structure would be used for the magnetic core.

This phenomenon combined with the relatively big airgap that partly decouples the branch-specific parts results in a significant common mode inductance as well as filtering of common mode currents. With the more sophisticated embodiments illustrated by FIGS. 2 and 3, the ratio of the CM (common mode) inductance and DM (differential mode) inductance can be adjusted by the ratio of airgaps in legs and the airgaps in the yokes.

Airgaps in the yokes are filled with air. No filler is used to ensure that the air can flow through. However, airgaps in the legs 60, 61, 61a, 61b, 62, 62a, 62b can be filled with some non-magnetic material. No metallic materials are highly preferred.

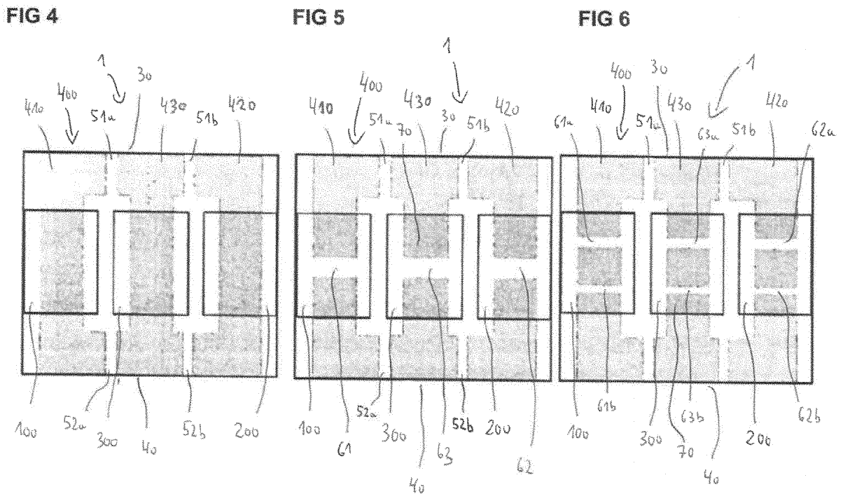

FIGS. 4 to 9 illustrate embodiments of various reactors which allow extending the concept shown in FIGS. 1 to 3 to three-phase applications. The concept of a reactor having at least one airgap in at least one of the yokes used in FIGS. 1 to 3 for two branch-specific magnetic parts can be used with three branch-specific magnetic parts as well. The de-coupling effect of the gaped yoke will also increase the CM inductance of the choke. Based on the magnetic energy required by an application, one or more airgaps in the legs can also be used. A combination of different shapes for the various core parts of the magnetic core 400, such as “L”, “T”, “C” and “I” can be used to achieve the desired magnetic performance. Some embodiments of the concept of three branch-specific magnetic parts are represented by FIGS. 4 to 9.

FIGS. 4 to 6 show various embodiments of a reactor/choke 1, wherein the magnetic core 400 comprises a first core part 410, a second core part 420 and a third core part 430. The three core parts 410, 420 and 430 may have the same material. The first and second core parts 410, 420 are configured as C-shaped parts, and the middle core part 430 is configured as a H-shaped part. Airgaps 51a, 51b are provided in the first yoke 30, and airgaps 52a, 52b are provided in the second yoke 40. A first winding 100 is placed on the first leg 10, a second winding 200 is placed on the second leg 20 and a third winding 300 is placed on the third leg 70. All the three windings are on different electrical potential and therefore are insulated properly from each other. With other words, there is not any electrical connection between the coils of the windings.

According to the embodiments of the reactor 1 shown in FIGS. 5 and 6, additional airgaps 60 are provided in the first leg 10 of the first core part 410, the second leg 20 of the second core part 420 and the third leg 70 of the third core part 430. FIG. 5 shows an embodiment of a reactor, wherein each of the legs 10, 20 and 70 respectively comprises one airgap 61, 62 and 63. FIG. 6 shows another embodiment of a reactor 1, wherein each of the legs 10, 20 and 70 comprises two airgaps 61a, 61b, 62a, 62b and 63a, 63b. The airgaps are thus provided in the windings.

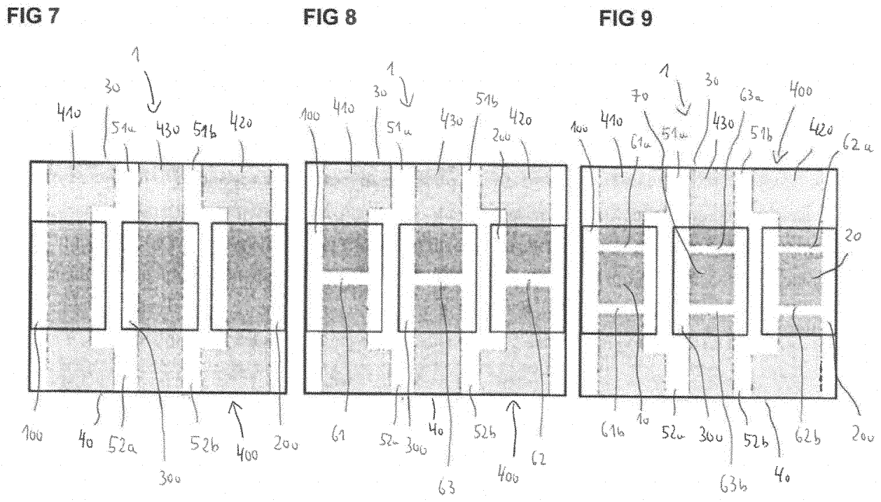

FIGS. 7 to 9 show other embodiments of a reactor 1 comprising a magnetic core 400 having a first core part 410, a second core part 420 and a third core part 430. The first core part 410 and the second core part 420 are respectively configured as a C-shaped structure. The first winding part 430 is configured as an I-shaped structure. The three core parts 410, 420 and 430 may have the same material.

A first winding 100 is placed on the first leg 10, a second winding 200 is placed on the second leg 20 and a third winding 300 is placed on the third leg 70. All the three windings are on different electrical potential and therefore are insulated properly from each other. With other words, there is not any electrical connection between the coils of the windings.

According to the embodiments of a reactor 1 shown in FIGS. 7 to 9, airgaps 51a, 51b are provided in the yoke 30. Furthermore, airgaps 52a, 52b are provided in the yoke 40. FIGS. 8 and 9 show embodiments of a reactor 1, wherein the legs 10, 20 and 70 additionally comprise at least one airgap 60. FIG. 8 shows an embodiment of a reactor 1, wherein each of the legs 10, 20 and 70 comprises one airgap 61, 62 and 63. According to the embodiment of the reactor 1 shown in FIG. 9, the leg 10 of the magnetic core part 410 comprises two airgaps 61a, 61b. The leg 20 of the second magnetic core part 420 has two airgaps 62a, 62b, and the leg 70 of the third magnetic core part 430 comprises two airgaps 63a and 63b.

Referring to the various embodiments of the reactor 1 shown in FIGS. 1 to 9, the number of airgaps must be defined by the design respectively. One or more airgap can be used in the yokes, i.e., the horizontal parts of the magnetic core. If the stored magnetic energy required by an application is below a certain level, legs, i.e., the vertical parts, of the magnetic core, without airgaps can be used. However, if high overload capability is required so that more magnetic energy must be stored by the inductor, one or more airgaps in the legs must be used to achieve the required magnetic performance, such as an inductance versus current (L vs I) characteristic (saturation curve).

The number of legs and windings as well equals to the number of each potentials of the connected circuit. In case of DC “+” and “−”, the reactor comprises two legs. In case of a three phase excitation L1, L2 and L3, the reactor comprises three legs.

The inductance over current characteristic of the reactor can be adjusted by the combination of the number of turns, the core cross-section and airgaps respectively. By varying the number of winding turns, the core cross-section and the number and sizes of the airgaps, the desired saturation that is required by the application could be reached.

The material of the magnetic core 400 of the different embodiments of the reactor/choke 1 of FIGS. 1 to 9 must be a ferromagnetic material. The fixing of the different core parts 410, 420 and 430 may be done on any way which can guarantee the defined airgap size. For example, if silicone-steel sheets stacked on top of each other welding can be an option, wherein load current and final application must be always considered. Details and parameters of the welding process such as number, width and depth of welding seams as well as material and geometry of the mounting plates must be defined individually adjusted to the application. Generally, mechanical fixing of each part of the reactor can be done any way, for example by gluing, screwing or welding, which ensures to have the defined airgap size.

Typically embodiments with the combination of two branch-specific pillars and winding may be used in DC applications. However, the concept is not limited to DC and can be used in any application, where one or two inductive component(s) is/are required. The branch-specific windings can be either connected internally to have a choke/reactor with relatively high inductance value resulted by the magnetic coupling of those, or provided with four outlets to have two chokes which are magnetically coupled. The coupling factor can be adjusted by the geometry of the design respectively.

The presented reactor/choke solution is best-suited to applications where the available space is seriously limited and forced air cooling is available, so that high energy-density is required. Typical application is a DC circuit of a frequency converter. However, it is not limited to that application and it will be appreciated that chokes/reactors designed according to the method described will be used in any inductor-related application.

As well as the advantage from a thermal aspect, the concept has a significant advantage from a magnetic point of view. This kind of coupling of the two magnetic circuits of the combination of each branch-specific winding and ferromagnetic material results in that the CM inductance—as well as the CM current filtering—is higher than for the conventional “UI”, “UU”, “E” or “EE” core concepts. This phenomenon is a result of the gap in the yokes. It partly decouples the two branch-specific parts. Therefore, the CM inductance—within certain limits—can be adjusted by the size of it. In the practically useful size range of the airgap, bigger airgap results in higher CM inductance which helps to guarantee the decant EMC performance of a frequency converter.

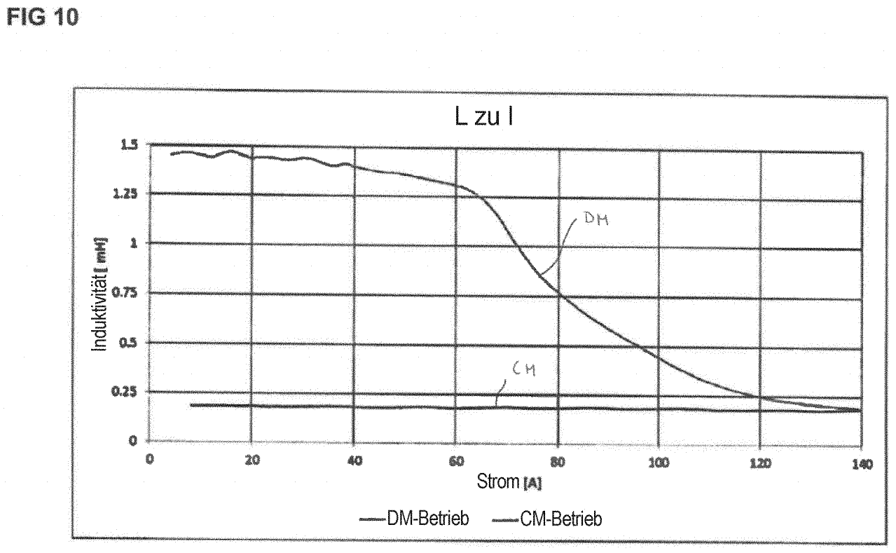

FIG. 10 shows a L vs I curve of a reactor comprising at least one airgap in the yoke of the magnetic core. From a magnetic point of view the additional advantage of this kind of coupling of the two magnetic circuits/magnetic core parts of the combination of each branch-specific winding and the L-shaped core parts, is that the CM inductance—and thus the CM current filtering—can be adjusted by the airgaps. In the exemplified embodiment of the reactor 1 shown in FIG. 10, the value of the CM inductance is 13% of the DM inductance at the linear phase. If this reactor would be built on a UI concept the CM inductance would be 25-30% lower.

1-15. (canceled)

16. A reactor with high common mode inductance, comprising:
at least one winding; and
a magnetic core having at least a first leg and a second leg, and at least a first yoke and a second yoke,
wherein the at least one winding is placed on at least one of the first leg and the second leg, and
wherein at least one of the first and the second yoke has at least one airgap.

17. The reactor of claim 16, wherein the reactor is configured to generate a magnetic field in the magnetic core such that the magnetic field is guided within the magnetic core from the first leg via the first yoke to the second leg and from the second leg via the second yoke to the first leg when a current flow is generated in the at least one winding.

18. The reactor of claim 16,
wherein the at least one winding comprises a first winding and a second winding, and
wherein the first winding is placed on the first leg and the second winding is placed on the second leg.

19. The reactor of claim 16,
wherein the first leg has an inner side face facing an inside of the magnetic core, and the second leg has an inner side face facing the inside of the magnetic core, and
wherein the first yoke has a front face facing to the inner side face of the second leg, and the second yoke has a front face facing to the inner side face of the first leg.

20. The reactor of claim 16,
wherein the magnetic core comprises at least a first core part and a second core part,
wherein the first core part comprises the first leg and the first yoke, the first leg and the first yoke being arranged so that the first core part has a first L-shaped structure, and
wherein the second core part comprises the second leg and the second yoke, the second leg and the second yoke being arranged so that the second core part has a second L-shaped structure.

21. The reactor of claim 20, wherein the at least one airgap comprises a first airgap and a second airgap, and wherein the first airgap is arranged in the first yoke and the second airgap is arranged in the second yoke so that the first and the second core part are arranged spaced apart from each other.

22. The reactor of claim 21, wherein the first core part and the second core part are arranged such that the first airgap is arranged in the first yoke so that a front face of the first yoke is arranged spaced apart from the second leg.

23. The reactor of claim 21, wherein the first core part and the second core part are arranged such that the first airgap is arranged in the first yoke so that a front face of the first yoke and an inner face of the second leg are arranged spaced apart from each other.

24. The reactor of claim 21, wherein the first core part and the second core part are arranged such that the second airgap is arranged in the second yoke so that a front face of the second yoke is arranged spaced apart from the first leg.

25. The reactor of claim 21, wherein the first core part and the second core part are arranged such that the second airgap is arranged in the second yoke so that a front face of the second yoke and an inner face of the first leg are arranged spaced apart from each other.

26. The reactor of claim 20,
wherein the magnetic core has at least a third core part comprising a third leg,
wherein the at least one winding comprises a third winding, and
wherein the third winding is placed on the third leg.

27. The reactor of claim 26, wherein the third leg has at least a fifth airgap.

28. The reactor of claim 26,
wherein the first and the second core part are respectively formed in a C-shape, and
wherein the third core part is formed in a T-shape or an I-shape.

29. The reactor of claim 16, wherein at least one of the first leg or the second leg has at least one other airgap.

30. The reactor of claim 29, wherein the first leg comprises at least a third airgap and the second leg comprises at least a fourth airgap.
